(19) United States
(12) Patent Application Publication
(10) Pub. No.: US 2006/0049149 A1
(43) Pub. Date: Mar. 9, 2006

(54) Plasma spray apparatus

(75) Inventor: Tadahiro Shimazu, Gifu-shi (JP)

Correspondence Address: Jeffrey J. King;GRAYBEAL JACKSON HALEY LLP, Suite 350, 155 - 108th Avenue NE, Bellevue, WA, 98004-5901, US

(73) Assignee: Shimazu Kogyo Yugenkaisha

(21) Appl. No.: 11/035,575

(22) Filed: Jan. 14, 2005

(30) Foreign Application Priority Data
Aug. 18, 2004 (JP) 2004-238033

(51) Int. Cl. B23K 9/00; B23K 9/02

(52) U.S. Cl. 219/121.47

(57) ABSTRACT

To provide a plasma spray apparatus, having a reduced number of jet ports for the working medium transformed into plasma, resulting in a simplified structure thereof, and even when the trajectory of the working medium becomes misaligned, the apparatus remains capable of producing a plasma flame that can properly melt the spray material; thus, the spray material can be used effectively. Two jet paths in the plasma spray apparatus are formed at both sides of one supply port for spray material 17 and are arranged so that the axial directions cross each other at the outside of the nozzle anode 11; two cathodes 13 are disposed inside the two jet paths 12; and the openings of the jet paths 12 are formed into elongated holes so that the center lines thereof are parallel to each other and the areas thereof are the same.

### FIELD OF THE INVENTION

The present invention relates to a plasma spray apparatus that transforms a working medium into plasma by means of an arc generated between the anode and the cathode, and after melting the spray material by means of working medium transformed into the plasma, accelerates and ejects the melted spray material onto an object to be treated, to carry out “thermal spraying”, which is a kind of surface finishing treatment.

### BACKGROUND OF THE INVENTION

When finishing a surface by “thermal spraying”, metals and ceramics can be used as the spray material, and a finished surface of extremely high quality can be obtained. Accordingly, various kinds of methods and apparatus have been developed. The inventor of the present invention also has proposed various related inventions, as set forth for example in Japanese Unexamined Patent Application Publication No. 60-129156, and Japanese Examined Patent Application Publication No. 4-55748. Other publications pertinent to understanding the field of the invention include Japanese Examined Utility Model Publication No. 43-2977; Japanese Unexamined Patent Application Publication No. 61-149265; Japanese Unexamined Patent Application Publication No. 57-4261; and U.S. Pat. No. 3,140,380.

The invention disclosed in Japanese Unexamined Patent Application Publication No. 60-129156 was devised to provide a novel plasma spray apparatus capable of not only preventing spray material from adhering, depositing or the like inside the nozzle electrodes increasing the life of the nozzle electrodes, but also when a powder spray material is used, capable of reliably feeding the material to the central area of the plasma flame while preventing the material from being reflected by the outer periphery of the plasma flame or passing through the flame and flying away, preventing un-melted particles from flying resulting in a largely increased spraying yield. Further, when a wire-like or rod-like spray material is used, the plasma spray apparatus is capable of supplying the material to the center of the flame without disturbing the flow of the plasma flame, forming fine powder of the material, melting the material uniformly and accelerating the flying speed of the material. And further, even when any state of the spray material such as powder state, wire state or rod state, the plasma spray apparatus is capable of forming a high density spray film by using the energy of the plasma flame effectively. And, as shown in FIG. 9-FIG. 11, a plurality of plasma flame ports are disposed to focus the plural flows of plasma flames to substantially one point, and a supply port of the spray material is disposed in the central area of the plasma flame ports to supply the material at substantially the central area of the flows of the plasma flames.

The foregoing plasma spray apparatus can achieve the above-mentioned object. However, as shown in FIG. 10, it is necessary to incorporate four jet ports and cathodes corresponding thereto in the plasma spray apparatus. Accordingly, because the structure of the plasma spray apparatus is very complicated, maintaining and servicing the apparatus requires an extremely long time and significant manpower.

Additionally, in the foregoing plasma spray apparatus, the axes of the four jet ports and the axis of the spray material supply port at the center must always be meticulously aligned with respect to each other. When the ports are not properly aligned with each other, as shown in FIG. 12, the spray material may not be completely melted, accelerated and ejected from the plasma spray apparatus.

Generally, in a plasma spray apparatus, the arc generated between the electrodes causes damage, particularly at the anode side. On the anode side, jet ports are formed as shown in FIG. 10. Damage to the anode causes the trajectory of the ejected spray material to change. Then, as shown in FIG. 12, the trajectory of the ejected working medium from each of the jet ports, which is transformed to plasma, is displaced from the intersection point 0 indicated in FIG. 12.

The intersecting point 0 is the point where the spray material ejected from the spray material supply port and the working medium transformed into plasma from the jet ports collide with each other. When the trajectory of the working medium is out of the alignment from the intersection point 0, the spray material will not be heated and accelerated satisfactorily. As a result, as indicated with dots in FIG. 12, the material simply flies away. That is, the spray material, which was not heated and melted satisfactorily, just flies away all around without being used as the material for the surface finishing; thus the material is consumed in vain.

Another plasma spray apparatus is described in Japanese Examined Patent Application Publication No. 4-55748 (incorporated herein by reference), which was designed to overcome certain deficiencies in previous plasma spray devices described in Japanese Examined Utility Model Publication No. 43-2977; Japanese Unexamined Patent Application Publication No. 61-149265; Japanese Unexamined Patent Application Publication No. 57-4261; and U.S. Pat. No. 3,140,380 (each incorporated herein by reference). As shown in FIG. 13, Japanese Examined Patent Application Publication No. 4-55748 discloses a plasma spray torch adapted to apply a voltage between the anodes, which are cooled down by water or the like, and the cathode, which is separated from the anodes, to transform working medium supplied between the electrodes into plasma gas. The device includes a discharge port for feeding spray material adjacent to the anodes or cathode, and thus operates to heat and melt the spray material by means of the plasma gas and eject the same there from to carry out the surface finishing. The cathodes are formed separately from the discharge port, and multiple cathodes are disposed around the discharge port. The discharge port is structured so as to be cooled down by water or the like, and the discharge port is provided within an opening formed in the anodes. The discharge port is disposed behind the generating point of the plasma gas. This plasma spray apparatus requires that “three lines” of cooling paths, indicated by reference numerals “21”, “31” and “41” in FIG. 13, have to be formed. Accordingly, the complexity of the structure renders it prone to frequent failures. This device also has four cathodes and “ring-like jet ports” for ejecting the working medium transformed into plasma. Thus, as with the plasma spray device described in Japanese Unexamined Patent Application Publication No. 60-129156, significant manpower and a long time are required for assembling, manufacturing and maintenance service.

Further, considering the thermal spraying which is a surface finishing made by using a spraying apparatus as described above, recently, needs for forming harder surface treated more uniformly has been increasing. That is, considering the aspect of the spray material used for forming the surface by means of the thermal spraying, recently, not only metals but also metal oxides such as alumina, various kinds of ceramics such as carbide metals, and mixtures thereof have been required.

Recently, the price of the spray materials including such ceramics and the like has been increasing. Accordingly, when such materials are used as the spray material, the “yield ratio” has to be increased. When a common metal such as iron or lead is used as the spray material, the quality of the finished surface is a more important factor than the yield ratio. However, when an expensive spray material is used, in addition to the increase of the quality of surface, the yield ratio also has to be increased.

That is to say, when carrying out thermal spraying with a spraying apparatus as described above, using a spray material such as iron, which is inexpensive and easy to obtain, the yield ratio of around 30% is acceptable. However when an expensive spray material as described above is used, the acceptable yield ratio is generally higher, at about least 60% or more.

### SUMMARY OF THE INVENTION

The present invention overcomes the foregoing problems and fulfills additional objects and advantages by providing a novel plasma spray apparatus having various distinct structural and performance attributes.

In certain exemplary embodiments of the invention, the plasma spray apparatus comprises a nozzle anode that communicates with a working medium path which is adapted to accommodate a working medium, a jet port formed as an elongated hole in communication with the working medium path, a cathode in communication with the working medium path, wherein the nozzle anode and cathode are operable to convey an electrical arc there between to transform the working medium into plasma to form a plasma flame that is ejected as a lingual-shaped plasma flame from the jet port, and a spray material supply port for supplying spray material directed toward the plasma flame to melt and accelerate the spray material.

In additional exemplary embodiments, the plasma spray apparatus comprises a nozzle anode that communicates with a working medium path which is adapted to accommodate a working medium, a cathode that communicates with the working medium path, a dual-array of jet ports consisting of only two jet ports that communicate with the working medium path, wherein the nozzle anode and cathode are operable to convey an electrical arc there between to transform the working medium into plasma to form plasma flames ejected from the jet ports, and a spray material supply port for supplying spray material into the plasma flames to melt and accelerate the spray material.

As will be readily understood by those of ordinary skill in the art, the invention further contemplates methods employing a novel plasma spray apparatus as described herein. These methods include novel methods of thermal spraying, methods of forming a plasma spray using a selected working medium and/or spray medium, methods of forming and projecting a plasma spray to produce a surface treatment on an object or surface, and methods for producing products by forming a surface treatment on the object or a surface thereof using a plasma spray device of the invention.

Within yet additional aspects of the invention, products formed according to the methods of the invention, employing a plasma spray apparatus as described herein, are provided. Such products formed by processes of the invention include products formed by an improved surface treatment process employing a plasma spray device according to the invention described herein.

### BRIEF DESCRIPTION OF THE DRAWINGS

FIG. 1 is a side view schematically showing a plasma spray apparatus in accordance with the present invention.

FIG. 2 is an enlarged side view of a plasma torch exemplifying a plasma spray apparatus of the invention, from which the handle and the drain tube cover are removed.

FIG. 3 is a front view of a plasma torch of the invention.

FIG. 4 is a bottom plain view of a plasma torch of the invention.

FIG. 5 is an enlarged transverse sectional view along the line 1-1 in FIG. 2.

FIG. 6 is a view of a plasma torch of the invention. FIG. 6(a) is a longitudinal sectional view along the line 2-2 in FIG. 5, and FIG. 6(b) is a front view thereof.

FIG. 7 is a longitudinal sectional view of a plasma torch of the invention along the line 2-3 in FIG. 5.

FIG. 8 is a perspective view schematically showing a state of a jet of a plasma flame.

FIG. 9 is a sectional view of a conventional plasma torch, which uses a fine particle material.

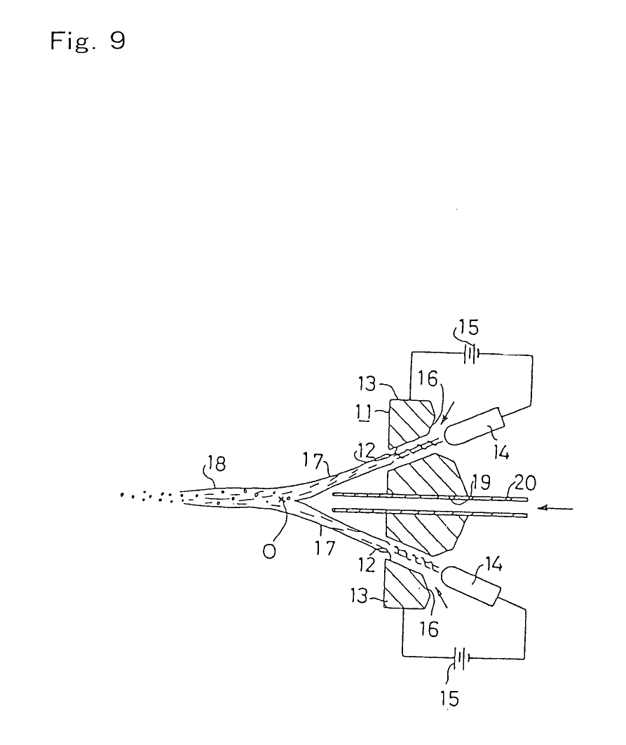

FIG. 10 is a front view of the plasma torch shown in FIG. 9.

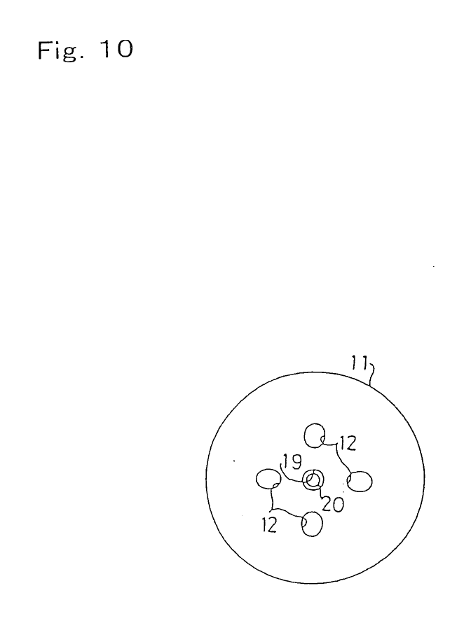

FIG. 11 is a sectional view of the conventional plasma torch, which uses a wire rod.

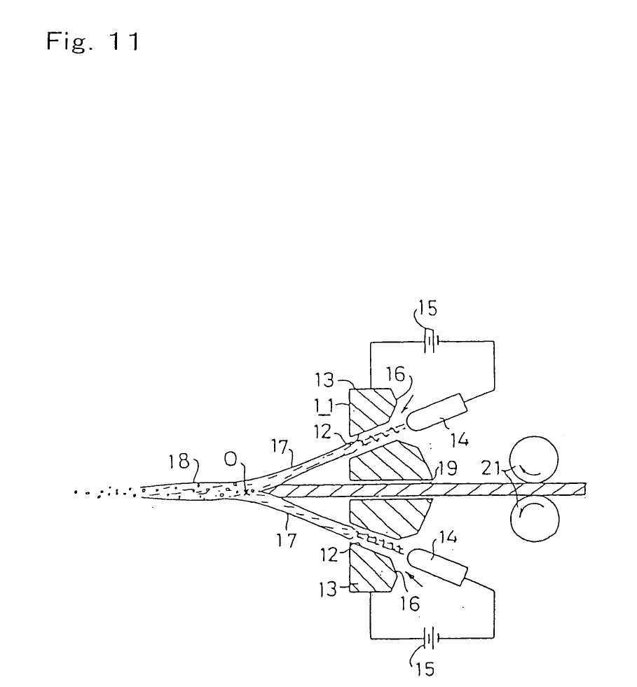

FIG. 12 is a sectional view schematically showing a state of misalignment of a plasma flame when the conventional plasma torch shown in FIG. 9 is used.

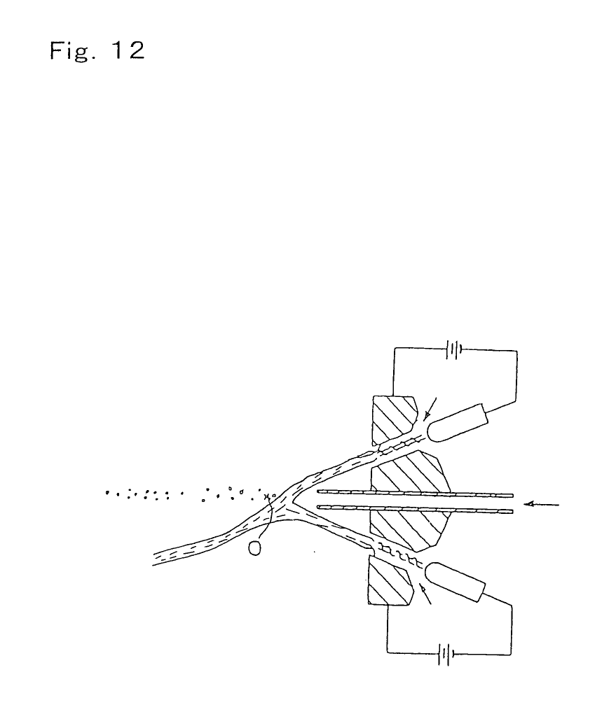

FIG. 13 is a sectional view showing another conventional plasma torch.

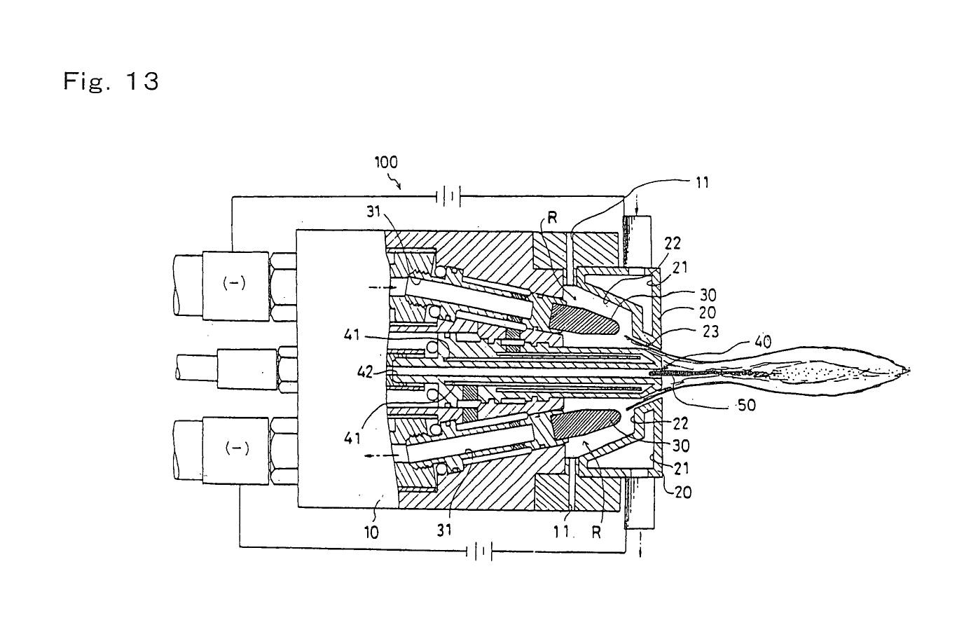

### DESCRIPTION OF EXEMPLARY EMBODIMENTS OF THE INVENTION

The following discussion is presented to enable a person skilled in the art to make and use the invention. Various modifications to the exemplified embodiments described herein will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

The inventor of the present invention investigated various aspects to improve previously-described plasma spray apparatus. As a result, the inventor found that a reason why four jet ports were previously determined to be necessary for working medium transformed into plasma is because the spray material must be carefully enclosed and heated.

Accordingly, an object of the present invention is to provide a plasma spray apparatus capable of reducing the number of the jet ports for the working medium transformed into plasma resulting in a simplified structure of the plasma spray apparatus, and even when the trajectory of the working medium is out of the alignment, the plasma forming flame, which more perfectly encloses the melted spray material, is still able to effectively use the spray material.

In order to solve the above problems, using the reference numerals shown in the drawings for exemplary embodiments of the invention, the spray apparatus of the invention employs the following exemplary means:

A plasma spray apparatus 100, comprising: a working medium path 14 through which a working medium 16 is supplied, a nozzle anode 11 having jet paths 12 in communication with the working medium path 14 and cathodes 13 disposed in the inner side thereof being interposed by the working medium path 14, in which the working medium 16 is transformed into plasma by means of arc 18 generated between the cathodes 13 and the nozzle anode 11 to form plasma flame F ejected from jet paths 12 and a spray material 17 is supplied into the plasma flame F thereby the spray material 17 is melted and accelerated.

In other detailed embodiments, the plasma spray apparatus 100 is characterized in that two jet paths 12 opened at both sides of a supply port 15 for the spray material 17 are formed. These two jet paths 12 are arranged so that the axial directions thereof cross each other at a point outside the nozzle anode 11, and two cathodes 13 are disposed at the inner side of the two jet paths 12. The openings of the jet paths 12 are formed into an elongated hole respectively so that the center lines 12a thereof are parallel to each other and the opening areas thereof are approximately the same.

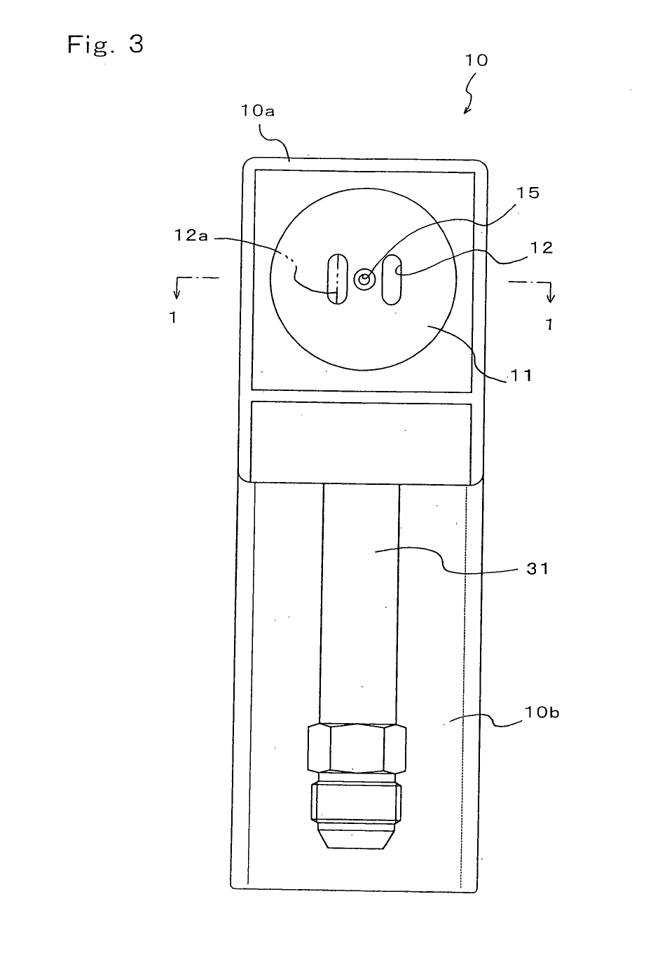

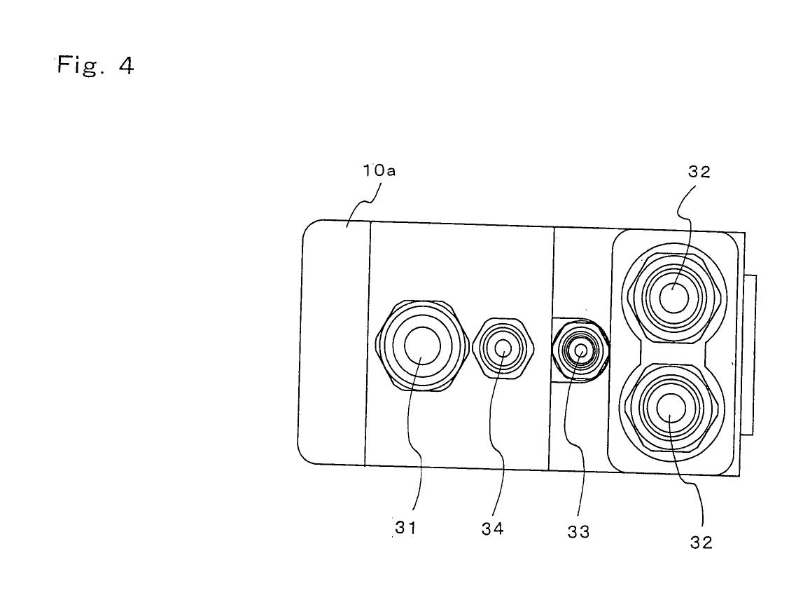

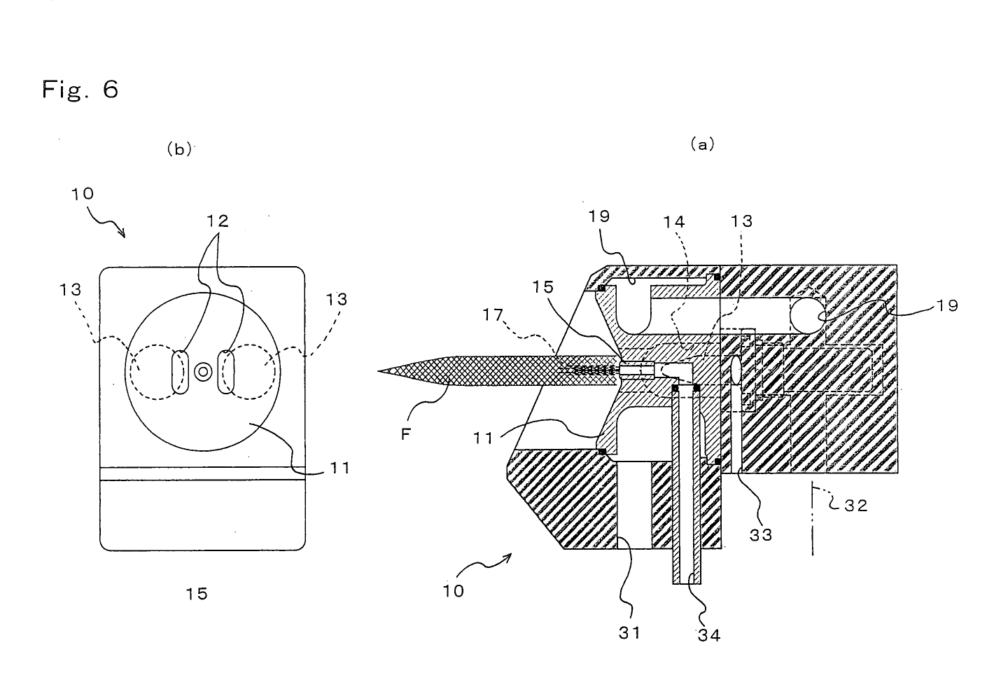

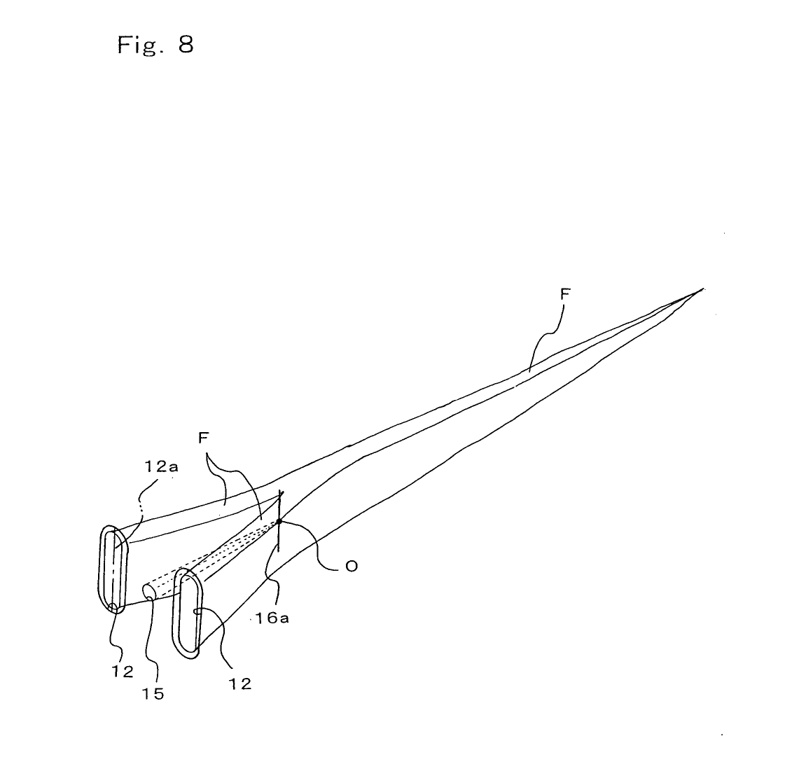

In the plasma spray apparatus 100 of the invention, the basic parts thereof are in certain aspects similar to those disclosed in Japanese Unexamined Patent Application Publication No. 60-129156, and Japanese Examined Patent Application Publication No. 4-55748. However, the instant invention differs from previously-described plasma spray apparatus in various distinct aspects. In exemplary embodiments, these novel aspects include a reduced number of cathodes 13 in the plasma torch 10, and a reduced number of jet paths 12 in the nozzle anode 11 formed corresponding thereto. In certain embodiments, the cathodes and jet paths are both reduced to a limited array of only two cathodes and only two jet paths, as shown in FIG. 3, FIG. 6(b) and FIG. 8. In such exemplary embodiments, each of the jet paths 12 is formed as a jet port having an elongated hole or aperture. By thus configuring the openings of the respective jet paths 12 as elongated holes, as shown in FIG. 4, only two jet paths 12 and cathodes 13, respectively, various advantages and improved functions of the apparatus are provided, as described herein.

When the openings of both jet paths 12 are configured as elongated holes, the sectional configuration (configuration in the direction perpendicular to the ejecting direction) of the working medium 16, which is transformed into plasma at a high temperature and ejected there from; i.e., the plasma flame F, which is ejected in flame being heated by the arc 18, is formed in a lingual-shape corresponding generally to the configuration of the elongated hole of the jet paths 12 as shown in FIG. 8. That is, the plasma flame F has such configuration that the width is larger towards the center line 12a of the jet paths 12. The plasma flame F ejected from the opening of the respective jet paths 12 has a maximum width equivalent to the configuration of the opening of the respective jet paths 12, and gets smaller as it moves away from the respective jet paths 12.

Further, the jet paths 12 are disposed on both sides of a spray material supply port 15, and the two jet paths 12 are arranged so that the axes thereof cross each other outside the nozzle anode 11. Accordingly, the plasma flames F ejected from the respective jet paths 12 come into contact with each other at the cross-line 16a shown in FIG. 8. In addition to the above, the spray material 17 ejected from the spray material supply port 15 is ejected toward the cross-line 16a of the plasma flames F. Accordingly, the spray material 17 is ejected between the two plasma flames F; thus, the spray material 17 is completely enclosed by the plasma flames F.

Due to the above-described arrangement, not only in the area between the plasma flames F but also in the area further front side than the cross-line 16a, any spray material 17 entering the plasma flames F is further heated, melted completely and satisfactorily accelerated. Thus, the yield ratio of the spray material 17 is satisfactorily increased. In certain exemplary embodiments of the invention, the yield ratio of the spray material 17 is enhanced to a yield ration of about 80% or more.

After a conventional plasma spray apparatus 100 is used for a long period of time, even minute flaws that have been generated in area of the nozzle anodes 11, where the arc 18 is formed, ordinarily cause misalignment of the ejection angle of the plasma flames F from the jet paths 12. However, the openings of the jet paths 12 in the current device are formed into elongated holes, and in exemplary embodiments this configuration functions to create an intersecting point O, as shown in FIG. 8, formed at a position such that the area of the intersecting point remains enclosed by the plasma flames F from the jet paths 12.

According to this aspect of the invention, the plasma flames F ejected from the elongated jet paths 12 are formed in a lingual shape which is elongated in the vertical direction as shown in FIG. 8. The cross-line 16a of the plasma jets thus directed, indicated with a solid line in FIG. 8, is likewise elongated in the vertical direction. Therefore, the ejecting direction of the spray material 17 from the spray material supply port 15 easily crosses with the long cross-line 16a at the intersecting point O.

In other words, in the plasma spray apparatus 100, the two jet paths 12 are formed in the nozzle anode 11 so as to sandwich the single spray material supply port 15. Even if the trajectory of the plasma flames F from each of the jet paths 12 after a long operation of the nozzle anode 11 become misaligned, the elongated holes of the jet paths 12 can accommodate the misalignment. Thus, the spray material 17 can be melted, accelerated and ejected stably in a consistent manner over time.

Further, because only two jet paths 12 are provided, the number of corresponding cathodes 13 is also only two. Accordingly, unlike the case for previously-described devices, it is not necessary to use many cathodes 13. Thus, the entirety of the plasma spray apparatus 100 can be fabricated with a reduced number of cathodes and jet paths yielding a substantially more compact size of the apparatus. Therefore, the assembly and maintenance service of the apparatus can be carried out more easily and at reduced cost.

In order to solve the above problems, the means adopted in the invention will often include a plasma spray apparatus 100 wherein, in the case where the voltage and the current applied between the nozzle anode 11 and each of the cathodes 13 are between about 30-50 volts and 700-900 amperes respectively, the length of the elongated holes of the jet paths 12 in the direction of the center line 12a of the opening is dimensioned to between about 7-9 mm, and the width of the elongated jet ports in a direction perpendicular to the center line 12a of the opening is adapted to between about 3-5 mm.

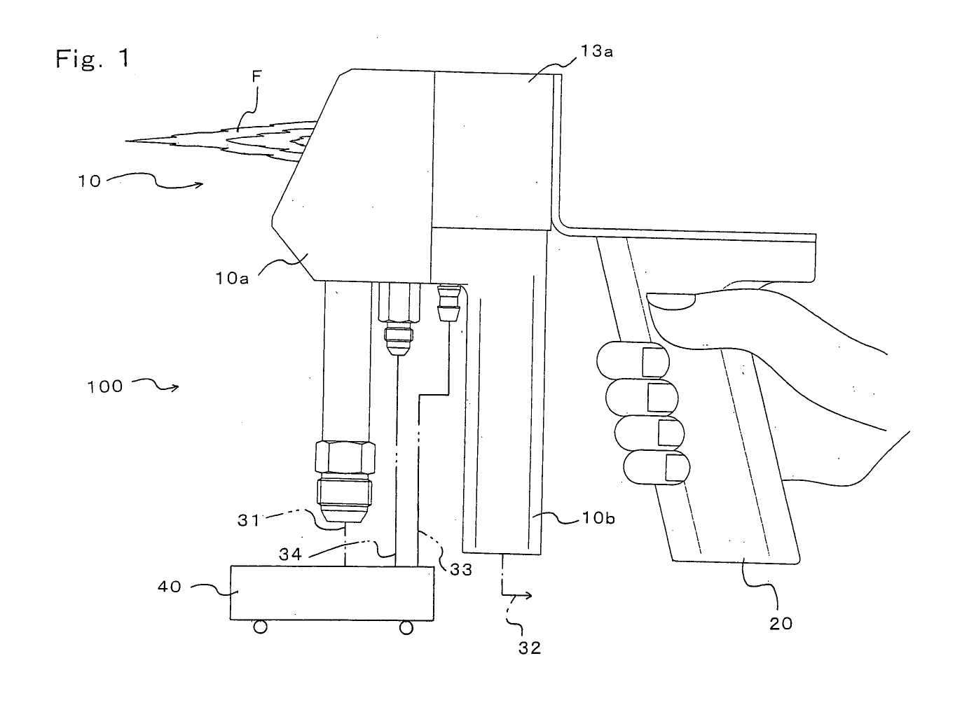

Accordingly, in a portable, hand-held sized plasma spray apparatus 100 of the invention, as shown in FIG. 1, the sizes and dimensions of the respective jet paths 12 are optimized in a novel configuration. In a portable, hand-held plasma spray apparatus 100 as described above, in many cases, the voltage applied between the nozzle anode 11 and the cathodes 13 is between about 30-50 volts, and the current is between about 700-900 amperes. In order to make the sum of the opening areas of the elongated holes of the two jet paths 12 of the invention compatible with that of the holes with a diameter of about 7 mm, a diameter that is conventionally used for the jet paths 12, the jet paths of the currently disclosed device will have apertures dimensioned within the above-described range.

As described herein, the present invention is partly characterized in its structure. That is, a plasma spray apparatus 100, comprising a working medium path 14 through which a working medium 16 is supplied, a nozzle anode 11 having jet paths 12 communicating with the working medium path 14, and cathodes 13 disposed in the inner side thereof being interposed by the working medium path 14, in which the working medium 16 is transformed into plasma by means of arc 18 generated between the cathodes 13 and the nozzle anode 11 to form plasma flame F ejected from the jet paths 12. A spray material 17 is supplied into the plasma flame F, thereby the spray material 17 is melted and accelerated

In certain embodiments, the plasma spray apparatus 100 is characterized in that two jet paths 12 open at both sides of a supply port 15 for the spray material 17. The openings of the jet paths 12 are formed into elongated holes and oriented such that the center lines 12a thereof are parallel to each other and the opening areas thereof are approximately the same. The two jet paths 12 are arranged so that axial directions thereof cross each other at a point outside the nozzle anode 11, and two cathodes 13 are disposed at the inner side of the two jet paths 12.

Owing to this arrangement, the plasma spray apparatus 100, which is superior in durability and performs effective thermal spraying, can be provided. In particular, the present invention provides a plasma spray apparatus that has fewer jet ports for the working medium transformed into plasma, which results in a simplified structure for the plasma spray apparatus. In addition, when the trajectory of the working medium is misaligned, the plasma flame is still able to properly melt the spray material; and thus, the spray material can be used effectively.

As described herein, an exemplary plasma spray apparatus 100 according to the invention is characterized as having the following structural features. Two cathodes 13 are disposed on both sides of the spray material supply port 15, and two jet paths 12 are formed in the nozzle anode 11 facing the respective cathodes 13. Center lines 12a of the openings of the respective jet paths 12 are arranged parallel to each other, and the openings are formed into elongated holes having about the same aperture areas. According to these embodiments, the following superior effects can be obtained:
(1) only two cathodes 13 are needed in the assembly resulting in a simplified structure accordingly,
(2) only two jet paths 12 in the nozzle anode 11 are formed, and thus, the structure can be made more compact than conventional spray devices,
(3) since each of the jet paths 12 are formed into an elongated hole, even when the centers of the plasma flames F from the jet paths 12 become misaligned, the misalignment can be accommodated with minimal detriment to performance; thus, the plasma torch 10 provides a superior durability,
(4) since the jet paths 12 are configured as elongated holes, the holes can be processed easily,
(5) since the spray material 17 can be melted, accelerated and ejected satisfactorily, unproductive wear of the spray material 17 can be minimized, and
(6) since the spray material 17 reliably passes through the cross-line 16a of the two plasma flames F at the intersecting point O, the supplied spray material 17 is satisfactorily melted, accelerated and ejected; and thus, finely finished thermal spraying can be obtained.

Accordingly, surface finishing for providing heat resistance can be carried out on, for example, a jet engine for an airplane, a brake shoe for an automobile, a rocker arm or piston crown of an engine, a rotary blade for a tractor, steel materials, and the like. Thus, the invention will find applicability in a wide variety of industries.

The present invention, which is structured as described above, will be described based on an exemplary plasma spray apparatus 100 as shown in the figures. FIG. 1 schematically shows the structure of a plasma spray apparatus 100 of the present invention. The plasma spray apparatus 100 has the plasma torch 10 for emitting the plasma flame F toward the metal surface, or the like, to be sprayed. The plasma torch 10 has a handle 20 integrally formed therewith, which is held by hand, and is covered by a torch cover 10a shown in FIG. 1-FIG. 3.

As schematically shown in FIG. 1, the working medium supply tube 33, spray material supply tube 34 and water supply tube 31 connect the supply unit 40 for supplying working medium 16, spray material 17 and coolant to the plasma torch 10.

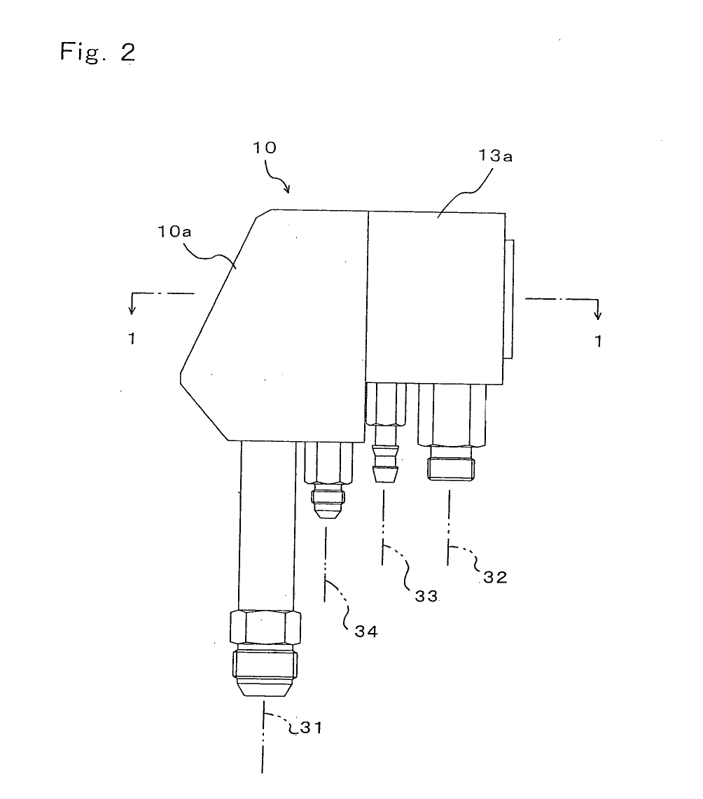

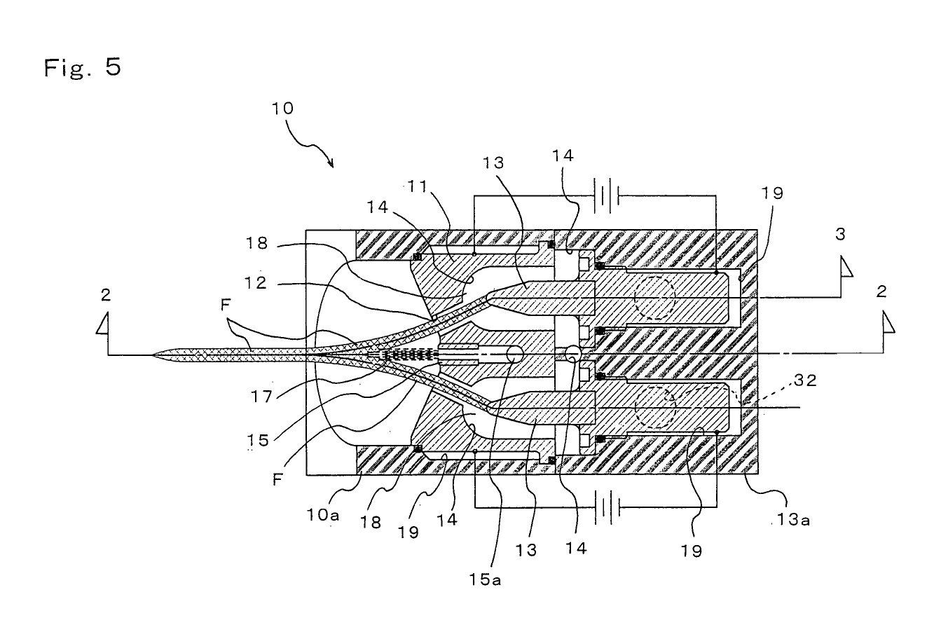

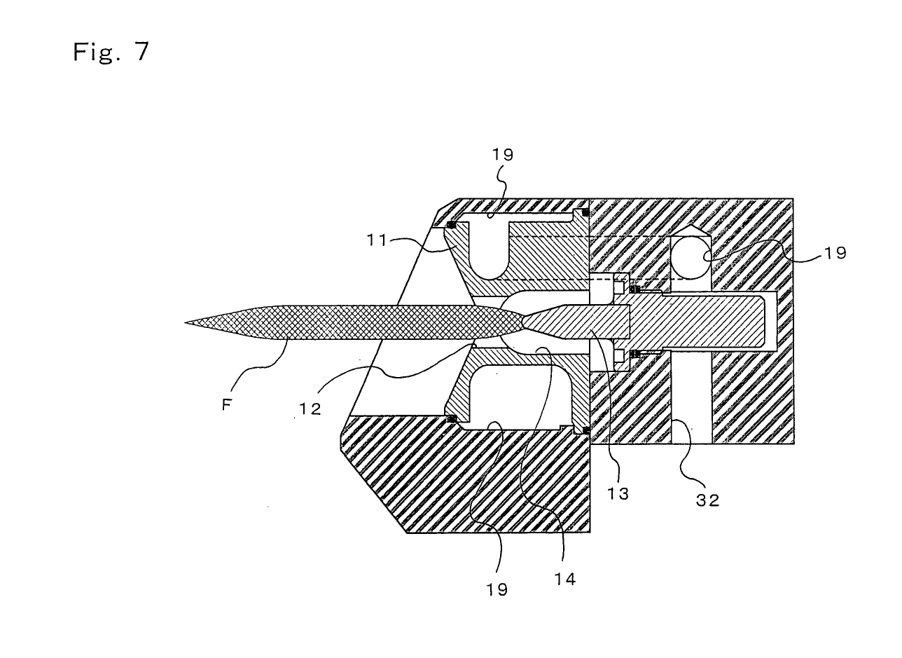

The plasma torch 10 is heated by the arc 18, which is generated therein. Accordingly, the plasma torch 10 should be cooled down during its operation. Therefore, as shown in FIG. 5-FIG. 7, coolant from the supply unit 40 is supplied through the water supply tube 31 into a water jacket 19 formed within the plasma torch 10, and it is arranged so that the periphery of the nozzle anode 11 and each of the cathodes 13 are cooled down with the coolant. And it is arranged so that the coolant after cooling is discharged to the outside through a drain tube 32 shown in FIG. 2 and FIG. 6.

The connection of the working medium supply tube 33 and the spray material supply tube 34 for supplying the working medium 16 and the spray material 17, and the above-described water supply tube 31 and the drain tube 32 are connected to the plasma torch 10 as shown in FIG. 1-FIG. 3. In particular, as shown in FIG. 4, it is arranged so that the above connection is made on the bottom face of the plasma torch 10. As shown in FIG. 1 and FIG. 2, two drain tubes 32 shown in FIG. 4 are covered by a drain tube cover 10b attached to the plasma torch 10.

As shown in FIG. 5-FIG. 7, the plasma torch 10 has the nozzle anode 11, which is connected with the positive side of the direct-current electricity, and the cathodes 13, which face to the nozzle anode 11 being interposed by the working medium path 14. The negative side of the direct-current electricity is connected to the cathodes 13.

As shown in FIG. 4 and FIG. 5, formed at the front side (left side in FIG. 5) of the nozzle anode 11 are two jet paths 12 for ejecting jet of the working medium 16 from the working medium path 14. Facing to each of the jet paths 12, the above-described cathodes 13 are positioned respectively. And as shown in FIG. 6(b), formed at the front side of the nozzle anode 11 and between the above-mentioned two jet paths 12, is a spray material supply port 15. To the spray material supply port 15, spray material 17 is supplied through the above-described spray material supply tube 34 via a spray material supply path 15a, which is formed in the nozzle anode 11.

As shown in FIG. 3, each of the jet paths 12 is formed as an elongated hole. The jet paths are arranged so that the center lines 12a (refer to the dashed line in FIG. 3) in the longitudinal direction thereof are parallel to each other, and each is spaced an equal distance from the center of the spray material supply port 15. In this exemplary embodiment, with respect to each of the jet paths 12, when the voltage and current applied between the nozzle anode 11 and the cathodes 13 are between about 30-50 volts and 700-900 amperes, respectively, the length of the jet paths 12, which are holes elongated in the direction of the center line 12a of the opening, is adapted to between about 7-9 mm, and the width of the jet paths in the direction perpendicular to the center line 12a of the opening is adapted to between about 3-5 mm.

When a voltage is applied to the nozzle anode 11, each of the cathodes 13 emits arc 18 shown in FIG. 5 toward the nozzle anode 11. In order to cause the cathodes 13 to generate the arc 18 uniformly with respect to the nozzle anode 11, the front end of the cathodes 13 is formed in a projection. In order to isolate each of the cathodes 13 with respect to the nozzle anode 11, as shown in FIG. 5, each of the cathodes 13 is attached to the inside of a non-conductive mounting member 13a, which is integrally formed at the back side of the nozzle anode 11. And to the mounting member 13a, the above-described handle 20 is attached as shown in FIG. 1.

The working medium path 14 supplies the working medium 16, which is supplied from the external of the plasma torch 10 via the working medium supply tube 33, to the periphery of the respective cathodes 13. And the working medium path 14 has a ball-like space for causing the arc 18 to fly between the cathode 13 and the nozzle anode 11. The working medium path 14 is formed so as to eject the jet of the working medium 16, which is transformed into plasma by the arc 18, through the above-described two jet paths 12 formed in the nozzle anode 11.

As shown in FIG. 3 and FIG. 6(b), formed between the two jet paths 12, which are the openings of the working medium paths 14, is the spray material supply port 15. The spray material supply port 15 ejects the spray material 17, which is fed from the supply unit 40 through the spray material supply tube 34 shown in FIG. 1 and the others, into a high temperature plasma flame F of the working medium 16 transformed into plasma. To this spray material supply tube 34, supply unit 40, which also supplies the working medium 16, is connected. Owing to this supply unit 40, the spray material 17 is ejected through the spray material supply port 15 shown in FIG. 3 in conjunction with the supply of the working medium 16 and the generation of the arc 18.

As for the working medium 16, a medium, which is ordinarily used in such apparatus as the plasma spray apparatus 100, is employed. For example, any one of argon gas, helium gas, nitrogen gas, or hydrogen gas, or a mix of these gases is employed. Also, as the spray material 17, various kinds of materials such as metals or ceramics used for spraying are applicable.

As described herein, the nozzle anode 11 produces the arc 18 between the nozzle anode 11 and the cathodes 13 to transform the working medium 16, which passes through the working medium path 14, into plasma; i.e., the nozzle anode 11 heats the working medium 16 to form plasma flame F. Accordingly, the nozzle anode 11 has to be cooled down. Therefore, in the plasma torch 10 of the best mode of the present invention, it is arranged so that a one-way water jacket 19, which goes adjacent the periphery of the nozzle anode 11 and each of the cathodes 13, is formed. And the drain tube 32 and the water supply tube 31 shown in FIG. 1-FIG. 3 are connected to the inlet and the outlet of the water jacket 19, respectively. That is, during the operation of the plasma spray apparatus 100, the coolant, which is fed from the supply unit 40 to the inside of the plasma torch 10 through the water supply tube 31, flows through the inside and the periphery of the nozzle anode 11 and around and adjacent to the cathodes 13, and is discharged to the outside through the drain tube 32.

From the foregoing it will be appreciated that, although specific embodiments of the invention have been described herein for purposes of illustration, various modifications may be made without deviating from the spirit and scope of the invention.

What is claimed is:

1. A plasma spray apparatus, comprising:
a nozzle anode that communicates with a working medium path which is adapted to accommodate a working medium;
a jet port formed as an elongated hole in communication with the working medium path;
a cathode in communication with the working medium path, wherein the nozzle anode and cathode are operable to convey an electrical arc there between to transform the working medium into plasma to form a plasma flame that is ejected as a lingual-shaped plasma flame from the jet port; and
a spray material supply port for supplying spray material directed toward the plasma flame to melt and accelerate the spray material.

2. The plasma spray apparatus of claim 1, wherein the jet port is formed as an elongated opening defined by the nozzle anode.

3. The plasma spray apparatus of claim 1, wherein the cathode is disposed at an inner side of the nozzle anode and is interposed from the nozzle anode by the working medium path.

4. The plasma spray apparatus of claim 1, wherein the apparatus features a dual-array of jet ports consisting of two elongate jet ports.

5. The plasma spray apparatus of claim 4, wherein each of the two jet ports defines an elongate opening in communication with the working medium path.

6. The plasma spray apparatus of claim 5, wherein the elongate openings of the jet ports are aligned with one another so that longitudinal midlines of the openings are approximately parallel to one another.

7. The plasma spray apparatus of claim 4, wherein the spray material supply port is located between the two jet ports and each of the two jet ports is spaced approximately the same distance from a center of the spray material supply port.

8. The plasma spray apparatus of claim 4, wherein each of the two elongate jet ports has a length of about 7-9 mm at a longitudinal midline of the opening, and a width of about 3-5 mm perpendicular to a midpoint of the longitudinal midline of the opening.

9. The plasma spray apparatus of claim 4, wherein the spray material supply port is located between the two jet ports and the jet ports are configured and dimensioned to direct plasma flames ejected from the two jet ports to converge and fully engulf spray material directed toward the plasma flames from the spray port.

10. The plasma spray apparatus of claim 1, further comprising two jet ports, wherein each jet port defines an elongate opening in communication with the working medium path, wherein the jet port openings are aligned with one another so that longitudinal midlines of the openings are approximately parallel to one another, and wherein the spray material supply port is located approximately equidistance between the two jet ports, whereby during operation of the spray apparatus two lingual-shaped plasma flames are ejected from the jet ports and converge outside the nozzle anode at a convergence point where the plasma flames fully engulf spray material directed outward from the supply port.

11. The plasma spray apparatus of claim 1, which provides for enhanced efficiency of heating and/or distribution of spray material to achieve an operational spray material yield ratio of at least about 60%, or greater.

12. The plasma spray apparatus of claim 11, which is operable to achieve a spray material yield ratio of between about 60%-95%, or greater.

13. The plasma spray apparatus of claim 11, which is operable to achieve a spray material yield ratio of at least about 80%.

14. The plasma spray apparatus of claim 1, wherein during operation a voltage and current applied between the nozzle anode and cathode are between about 30-50 volts and 700-900 amperes, respectively.

15. The plasma spray apparatus of claim 14, wherein the apparatus features a dual-array of jet ports consisting of two elongate jet ports each having an opening length of about 7-9 mm at a longitudinal midline of the opening, and an opening width of about 3-5 mm perpendicular to a midpoint of the longitudinal midline of the opening.

16. A plasma spray apparatus, comprising:
a nozzle anode that communicates with a working medium path which is adapted to accommodate a working medium;
a cathode that communicates with the working medium path;
a dual-array of jet ports consisting of only two jet ports that communicate with the working medium path;
wherein the nozzle anode and cathode are operable to convey an electrical arc there between to transform the working medium into plasma to form plasma flames ejected from the jet ports; and
a spray material supply port for supplying spray material into the plasma flames to melt and accelerate the spray material.

17. The plasma spray apparatus of claim 16, wherein the jet ports are formed as openings through the nozzle anode.

18. The plasma spray apparatus of claim 16, wherein the cathode is disposed at an inner side of the nozzle anode and is interposed from the nozzle anode by the working medium path.

19. The plasma spray apparatus of claim 16, wherein each of the two jet ports defines an elongate opening in communication with the working medium path.

20. The plasma spray apparatus of claim 19, wherein the elongate jet port openings are aligned with one another so that longitudinal midlines of the openings are approximately parallel to one another, and wherein the spray material supply port is located approximately equidistance between the two jet ports, whereby during operation of the spray apparatus two lingual-shaped plasma flames are ejected from the jet ports and converge outside the nozzle anode at a convergence point where the plasma flames fully engulf spray material directed outward from the supply port.

21. The plasma spray apparatus of claim 16, which provides for enhanced efficiency of heating and/or distribution of spray material to achieve an operational spray material yield ratio of at least about 60%, or greater.

22. The plasma spray apparatus of claim 16, which is operable to achieve a spray material yield ratio of between about 60%-95%, or greater.

23. The plasma spray apparatus of claim 16, which is operable to achieve a spray material yield ratio of at least about 80%.

24. The plasma spray apparatus of claim 16, wherein during operation a voltage and current applied between the nozzle anode and cathode are between about 30-50 volts and 700-900 amperes, respectively.

25. The plasma spray apparatus of claim 16, wherein each of the two elongate jet ports has a length of about 7-9 mm at a longitudinal midline of the opening, and a width of about 3-5 mm perpendicular to a midpoint of the longitudinal midline of the opening.

26. A plasma spray apparatus, comprising:
a nozzle anode that communicates with a working medium path which is adapted to accommodate a working medium;
a cathode disposed at an inner side of the nozzle anode that communicates with the working medium path;
at least one jet port in communication with the working medium path, said jet port formed as an elongated opening, whereby when an electrical arc is formed between the nozzle anode and cathode a working medium is transformed into plasma to form a lingual-shaped plasma flame that is ejected from the jet port; and
spray material supply means for supplying spray material into the plasma flame to melt and accelerate the spray material.

27. A plasma spray apparatus, comprising:
a nozzle anode defining an elongated jet path that communicates with a working medium path which is adapted to accommodate a working medium;
a cathode separated from the nozzle anode by the working medium path, wherein the nozzle anode and cathode are operable in connection with electric current supply means to generate an electrical arc to transform the working medium into plasma to form a plasma flame that is ejected from the jet path; and
a spray material supply mechanism to direct spray material toward the plasma flame to melt and accelerate the spray material.

28. A plasma spray apparatus, comprising:
a nozzle anode that communicates with a working medium path which is adapted to accommodate a working medium;
a cathode that communicates with the working medium path;
two elongate jet port openings aligned with one another so that longitudinal midlines of the openings are approximately parallel to one another; and
a spray material supply port located between the two elongate jet ports.

29. A plasma spray apparatus according to claim 28, wherein during operation a voltage and current applied between the nozzle anode and cathode are between about 30-50 volts and about 700-900 amperes, respectively, wherein lengths of the jet ports at center lines of the openings thereof is between about 7-9 mm, and wherein widths of the jet ports along a line perpendicular to the center lines of the openings are between about 3-5 mm.
